(19) United States
(12) Patent Application Publication
(10) Pub. No.: US 2026/0104110 A1
(43) Pub. Date: Apr. 16, 2026

(54) TUBE FASTENING STRUCTURE

(71) Applicant: HANWHA AEROSPACE CO., LTD., Changwon-si (KR)

(72) Inventor: Jae Youl HER, Changwon-si (KR)

(73) Assignee: HANWHA AEROSPACE CO., LTD., Changwon-si (KR)

(21) Appl. No.: 19/059,810

(22) Filed: Feb. 21, 2025

(30) Foreign Application Priority Data
Oct. 16, 2024 (KR) 10-2024-0141450

(51) Int. Cl. F16L 5/00

(52) U.S. Cl. CPC F16L 5/00

(57) ABSTRACT

A tube fastening structure includes a tube configured to supply a fluid to a fluid supply target, a support portion through which the tube passes, the support portion being fixed to a case, and a rotation prevention ring coupled to the tube and having one side configured to be bent and coupled to the support portion.

### CROSS-REFERENCE TO RELATED APPLICATION

This application is based on and claims priority under 35 U.S.C. §119 to Korean Patent Application No. 10-2024-0141450, filed on October 16, 2024, in the Korean Intellectual Property Office, the disclosure of which is incorporated by reference herein in its entirety.

### BACKGROUND

### Field

The present disclosure relates to a tube fastening structure. More particularly, the present disclosure relates to a tube fastening structure in which rotation of a tube may be prevented by a support portion having a slot and a rotation preventing unit having a protrusion.

### Description of Related Art

A tube fastening structure is a structure for connecting an outside to an inside that includes fluid supply target by using a tube in order to supply or recover a fluid from the outside to the fluid supply target located in the inside. It is necessary to prevent the tube from rotating and loosening during an operation of the tube fastening structure.

Methods of preventing tube rotation in the related art include a method of welding or brazing a tube to a case or a method of fixing a tube with a safety wire or serrating a tube to a case. However, the above methods have limitations in terms of work method and space because the case itself has to be disassembled in case of maintenance due to fluid leakage, etc., or maintenance has to be performed while the tube is fixed to the case. Also, the above methods fail to absorb radial or axial thermal displacement of the case or a fluid supply target.

### SUMMARY

Provided is a tube fastening structure in which rotation of a tube may be prevented by using a support portion having a slot and a rotation preventing unit having a protrusion.

According to an aspect of the present disclosure, a tube fastening structure includes: a tube configured to supply a fluid to a fluid supply target; a support portion through which the tube passes, the support portion being fixed to a case; and a rotation prevention ring coupled to the tube and including one side configured to be bent and coupled to the support portion.

The tube may include a ring coupling portion to which the rotation prevention ring is coupled. The ring coupling portion may include a stepped portion protruding in an axial direction of the tube.

The support portion may include at least one slot extending in a radial direction of the tube.

The at least one slot may include a plurality of slots. Each of the plurality of slots may be arranged at equal intervals in a circumferential direction of the tube.

The case may include: a first case supporting the fluid supply target; and a second case at an outer side compared to the first case from the fluid supply target, the first case being closer to the fluid supply target than the second case. The support portion may further include a case fixing portion coupled and fixed to an outer surface of the second case.

The tube fastening structure may further include a bushing coupled to a first end of the tube. The first case may be coupled and fixed to an outer surface of the first end of the tube.

The rotation prevention ring may include: a ring body contacting an outer circumferential surface of the tube and extending in a circumferential direction of the tube; and at least one protrusion protruding from a first side of the ring body in an axial direction of the tube.

The at least one protrusion may include a plurality of protrusions. The plurality of protrusions may be spaced apart from each other in the circumferential direction of the tube. An interval between two adjacent protrusions from among the plurality of protrusions may be different from another interval between two other adjacent protrusions from among the plurality of protrusions.

The at least one protrusion may be configured to be bent outward in a radial direction of the tube.

According to another aspect of the present disclosure, a tube fastening structure includes: a tube configured to supply a fluid to a fluid supply target; a support portion through which the tube passes, the support portion being fixed to a case; and at least one rotation prevention strip coupled to the tube and including one side configured to be bent and coupled to the support portion.

The tube may include at least one strip coupling portion to which the at least one rotation prevention strip is coupled.

The support portion may include at least one slot extending in a radial direction of the tube.

The at least one slot may include a plurality of slots. The plurality of slots may be arranged at equal intervals in a circumferential direction of the tube.

The case may include: a first case supporting the fluid supply target; and a second case at an outer side compared to the first case from the fluid supply target, the first case being closer to the fluid supply target than the second case. The support portion may further include a case fixing portion coupled and fixed to an outer surface of the second case.

The tube fastening structure may further include a bushing coupled to a first end of the tube. The first case may be coupled and fixed to an outer surface of the first end of the tube.

The at least one rotation prevention strip may include a plurality of rotation prevention strips. The plurality of rotation prevention strips may be spaced apart from each other in a circumferential direction of the tube. An interval between two adjacent rotation prevention strips from among the plurality of rotation prevention strips may be different from another interval between two other adjacent rotation prevention strips from among the plurality of rotation prevention strips.

The at least one rotation prevention strip may include: a strip body contacting an outer circumferential surface of the tube and extending in a direction perpendicular to an axial direction of the tube; and a protrusion protruding from a first side of the strip body in the axial direction of the tube.

The protrusion may be configured to be bent outward in a radial direction of the tube.

According to yet another aspect of the present disclosure, a tube fastening structure includes: a tube configured to supply a fluid to a fluid supply target; a support portion through which the tube passes, the support portion being fixed to a case and comprising at least one slot extending in a radial direction of the tube; and a rotation prevention assembly coupled to the tube and including at least one protrusion protruding from one side in an axial direction of the tube.

The at least one protrusion may be configured to be bent outward in the radial direction of the tube and may be configured to be inserted into the at least one slot.

### BRIEF DESCRIPTION OF DRAWINGS

The above and other aspects, features, and advantages of certain embodiments will be more apparent from the following description taken in conjunction with the accompanying drawings, in which:

FIG. 1 is a cross-sectional view illustrating a tube fastening structure according to various embodiments;

FIG. 2 is an exploded perspective view illustrating a tube fastening structure according to various embodiments;

FIG. 3 is a plan view illustrating a support portion according to various embodiments;

FIG. 4 is a view illustrating a state where a rotation prevention ring is unfolded according to various embodiments;

FIG. 5 is a perspective view illustrating a state where the rotation prevention ring is coupled to a tube according to various embodiments;

FIG. 6 is a plan view illustrating the rotation prevention ring coupled to the tube;

FIG. 7 is a view illustrating a state where the rotation prevention ring is moved to couple one of a plurality of protrusions to one of a plurality of slots according to various embodiments;

FIG. 8 is a view illustrating a process of coupling a second protrusion to a first slot by rotating the tube to which the rotation prevention ring is coupled according to carious embodiments;

FIG. 9 is a view illustrating a state where the support portion and the rotation prevention ring are coupled to each other according to various embodiments;

FIG. 10 is a cross-sectional view illustrating a tube fastening structure according to various embodiments;

FIG. 11 is an exploded perspective view illustrating a tube fastening structure according to various embodiments;

FIG. 12 is a view illustrating a rotation prevention strip according to various embodiments;

FIG. 13 is a view illustrating a state where the rotation prevention strip is coupled to a tube according to various embodiments;

FIG. 14 is a plan view illustrating the rotation prevention strip coupled to the tube;

FIG. 15 is a view illustrating a state where the tube to which the rotation prevention strip is coupled is rotated to couple one of a plurality of protrusions to one of a plurality of slots according to various embodiments;

FIG. 16 is a view illustrating a process of coupling a fifth protrusion to a second slot by rotating the tube to which the rotation prevention strip is coupled according to various embodiments; and

FIG. 17 is a view illustrating a state where a support portion and the rotation prevention strip are coupled to each other according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in more detail with reference to the accompanying drawings. The described embodiments, however, may have various modifications and may be embodied in different forms, and should not be construed as being limited to only the illustrated embodiments herein. Further, each of the features of the various embodiments may be combined with each other, in part or in whole. Each embodiment may be implemented independently of each other or may be implemented together in an association. The described embodiments are provided as examples so that this disclosure will be thorough and complete, and will fully convey the aspects of the disclosure to those skilled in the art. It should be understood that the disclosure covers all the modifications, equivalents, and replacements within the idea and technical scope of the disclosure. Accordingly, processes, elements, and techniques that are not necessary to those having ordinary skill in the art for a complete understanding of the embodiments of the disclosure may not be described.

Unless otherwise noted, like reference numerals, characters, or combinations thereof denote like elements throughout the attached drawings and the written description, and thus, descriptions thereof will not be repeated. Further, parts that are not related to, or that are irrelevant to, the description of the embodiments might not be shown to make the description clear.

In the drawings, the relative sizes of elements, layers, and regions may be exaggerated for clarity. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the disclosure. Thus, embodiments disclosed herein should not be construed as limited to the illustrated shapes of regions, but are to include deviations in shapes that result from, for instance, manufacturing.

The regions illustrated in the drawings are schematic in nature and their shapes are not intended to illustrate the actual shape of a region of a device and are not intended to be limiting. Additionally, as those skilled in the art would realize, the described embodiments may be modified in various ways, all without departing from the spirit or scope of the disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form to avoid unnecessarily obscuring various embodiments.

Spatially relative terms, such as “beneath,” “below,” “lower,” “lower side,” “under,” “above,” “upper,” “upper side,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” may encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “coupled to” another element, layer, region, or component, it may be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it may be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a guide plate, or the like is formed on another portion, a forming direction is not limited to an upper direction but includes forming the portion on a side surface or in a lower direction. On the contrary, when a portion of a layer, a film, an area, a guide plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it may be the only element or layer between the two elements or layers, or one or more intervening elements or layers may also be present.

It will be understood that when an element, layer, region, or component is referred to as being “fixed to,” another element, layer, region, or component, it may be fixed to the other element such that it may not be able to move in one or more directions or rotate in one or more directions. For the purposes of this disclosure, expressions such as “at least one of,” or “any one of,” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terms used in the present application are merely used to describe specific embodiments, and are not intended to limit the disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components. However, these terms do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations (e.g., deviations due to the limitations of a measurement system) in measured or calculated values that would be recognized by those of ordinary skill in the art. For example, “about” may mean within one or more standard deviations, or within ± 30%, 20%, 10%, 5% of the stated value.

Unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

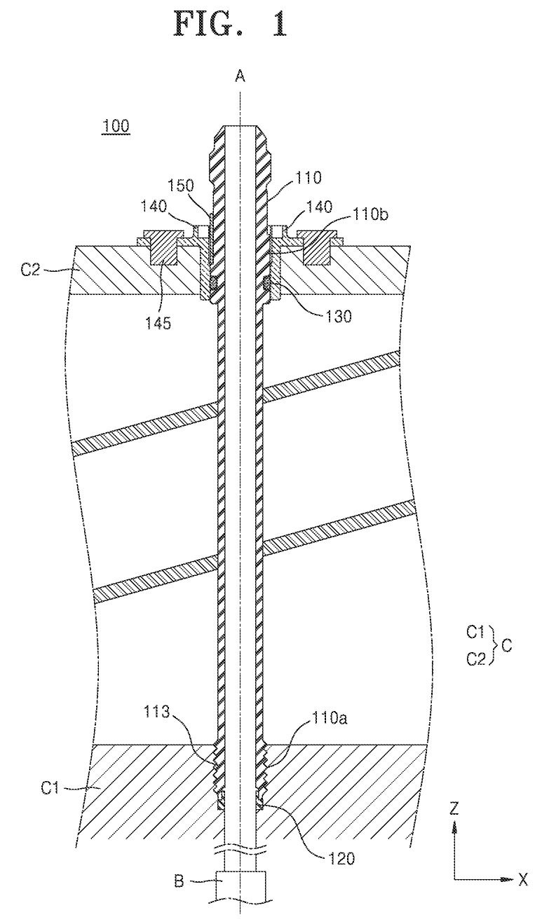

Hereinafter, a tube fastening structure according to an embodiment will be described with reference to FIGS. 1 to 17.

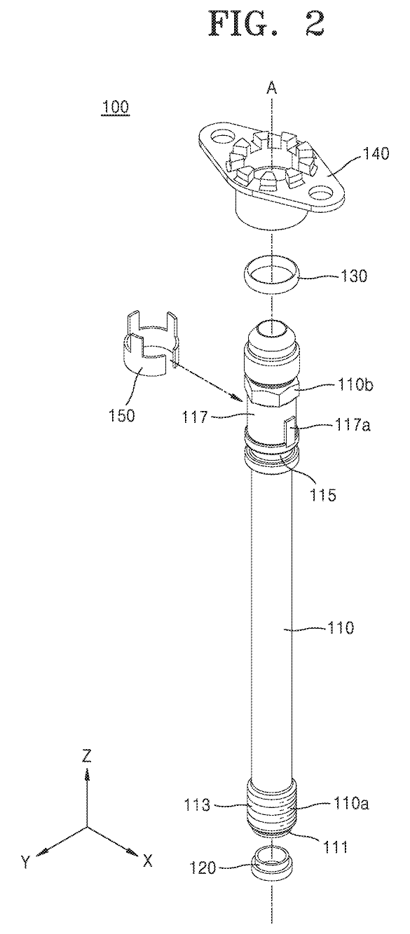

FIG. 1 is a cross-sectional view illustrating a tube fastening structure 100, according to various embodiments. FIG. 2 is an exploded perspective view illustrating the tube fastening structure 100, according to various embodiments.

The tube fastening structure 100 may be a structure for connecting an outside and an inside that includes a fluid supply target by using a tube in order to supply or recover a fluid from the outside to a fluid supply target B located in the inside. The fluid supply target B may include any device requiring supply or recovery of a fluid. For example, the fluid supply target B may include a sump of a bearing supporting a rotating body. The fluid may include oil.

The tube fastening structure 100 may be provided across a plurality of cases C. The cases C may include a first case C1 and a second case C2. Referring to FIG. 1, the first case C1 may support the fluid supply target B. The second case C2 may be located at an outer side than the first case C1 from the fluid supply target B.

The tube fastening structure 100 may include a tube 110, a bushing 120, a contact member 130, a support portion 140, and a rotation prevention ring 150.

The tube 110 may supply a fluid to the fluid supply target B. The tube 110 may be provided across both the first case C1 and the second case C2. That is, referring to FIG. 1, the tube 110 may pass through both the first case C1 and the second case C2 to connect the outside of the second case C2 to the fluid supply target B located in the inside of the first case C1.

The tube 110 may include a bushing coupling portion 111, a case coupling portion 113, a contact member coupling portion 115, and a ring coupling portion 117.

The bushing 120 described below may be coupled to the bushing coupling portion 111. Referring to FIGS. 1 and 2, the bushing coupling portion 111 may be located at a first end 110a of the tube 110. The bushing coupling portion 111 may have a shape corresponding to a shape of the bushing 120 so that the bushing coupling portion 111 is compressed without a gap when coupled to the bushing 120.

The first case C1 may be coupled to the case coupling portion 113. Referring to FIGS. 1 and 2, the case coupling portion 113 may be located on an outer surface of the first end 110a of the tube 110. In various embodiments, the case coupling portion 113 may include a thread. That is, the case coupling portion 113 may be screwed to the first case C1. In other words, the tube 110 may be coupled and fixed to the first case C1 by rotating the tube 110. That is, the outer surface of the first end 110a of the tube may be coupled and fixed to the first case C1.

The contact member 130 described below may be coupled to the contact member coupling portion 115. Referring to FIGS. 1 and 2, the contact member coupling portion 115 may be located on an outer surface of a second end 110b of the tube 110 contacting the support portion 140 described below. The contact member coupling portion 115 may be engraved so that the contact member 130 is coupled and fixed to the contact member coupling portion 115.

The rotation prevention ring 150 described below may be coupled to the ring coupling portion 117. Referring to FIGS. 1 and 2, the ring coupling portion 117 may be located on the outer surface of the second end 110b of the tube 110. The ring coupling portion 117 may include a stepped portion 117a. Referring to FIG. 2, the stepped portion 117a may protrude by extending in an axial direction A of the tube 110.

As the stepped portion 117a is provided, when the rotation prevention ring 150 described below is coupled to the ring coupling portion 117, the rotation prevention ring 150 may be fixed without rotating separately from the tube 110 in a circumferential direction P of the tube 110. That is, the tube 110 and the rotation prevention ring 150 coupled to the tube 110 may integrally rotate or stop in the circumferential direction P of the tube 110 due to the stepped portion 117a. In other words, when a torque is applied to the tube 110, the rotation prevention ring 150 may move together with the tube 110 in the circumferential direction P of the tube 110 due to the stepped portion 117a.

Referring to FIGS. 1 and 2, the bushing 120 may be coupled to the first end 110a of the tube 110. The bushing 120 may be coupled to the tube 110 and compressed on the tube 110. In various embodiments, a material of the bushing 120 may include copper. As the bushing 120 is compressed to the tube 110, fluid leakage of the tube 110 may be prevented. As the bushing 120 may be separated from the tube 110, the bushing 120 may be easily replaced when a problem occurs.

Referring to FIGS. 1 and 2, the contact member 130 may be located between the tube 110 and the support portion 140 described below. The contact member 130 may be coupled to the contact member coupling portion 115. In various embodiments, the contact member 130 may include an O-ring.

Due to the contact member 130, movement of a fluid between the tube 110 and the support portion 140 may be prevented. That is, unnecessary movement of a fluid into a through-hole of the second case C2 formed as the tube 110 passes through the second case C2 may be prevented. As the tube 110 and the support portion 140 are in close contact with each other by the contact member 130, a force for fixing the tube 110 to the support portion 140 may increase.

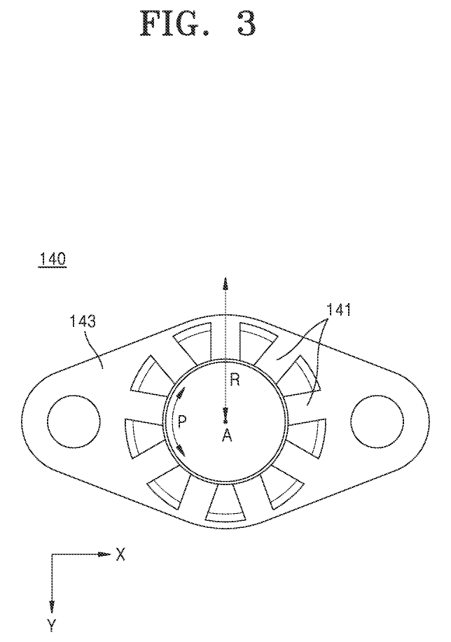

FIG. 3 is a plan view illustrating the support portion 140, according to various embodiments.

The axial direction A of the tube 110, the circumferential direction P of the tube 110, and a radial direction R of the tube 110 are illustrated in FIG. 3. In the following drawings, the directions A, P, and R are not shown to avoid complicating the drawings.

The support portion 140 may prevent the tube 110 from moving in the radial direction R of the tube 110, in other words, a direction perpendicular to the axial direction A of the tube 110. Referring to FIGS. 1 and 2, the tube 110 may pass through the support portion 140. The support portion 140 may be fixed to the case C. In detail, the support portion 140 may be fixed to the second case C2. The support portion 140 may include a slot 141, a case fixing portion 143, and a fixing member 145.

The slot 141 may prevent rotation of the tube 110 by fixing the rotation prevention ring 150 described below in the circumferential direction P of the tube 110. Referring to FIG. 3, the slot 141 may be extending in the radial direction R of the tube 110. A depth of the slot 141 is not particularly limited. A width of the slot 141 may correspond to a protrusion 153 of the rotation prevention ring 150 described below.

At least one slot 141 may be formed and extend in the radial direction R of the tube 110. In other words, a plurality of slots 141 may be formed and extend in the radial direction R of the tube 110. As shown in FIG. 3, each of the plurality of slots 141 may be arranged at equal intervals in the circumferential direction P of the tube 110.

The case fixing portion 143 may be coupled and fixed to an outer surface of the second case C2. Referring to FIGS. 2 and 3, the case fixing portion 143 may have a plate shape to stably contact the second case C2. A plurality of through holes through which the fixing member 145 described below may pass may be formed in the case fixing portion 143.

The fixing member 145 may fix the case fixing portion 143 to the outer surface of the second case C2. A fixing method is not particularly limited. In an embodiment, the fixing member 145 may be screwed to the second case C2. A plurality of fixing members 145 may be provided.

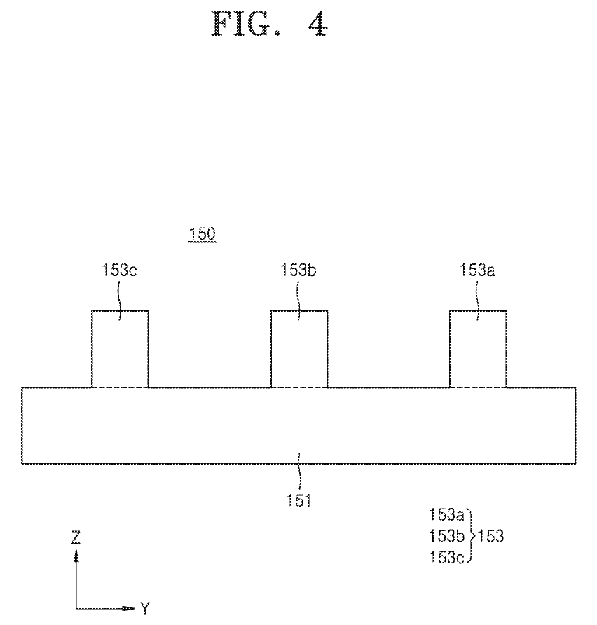

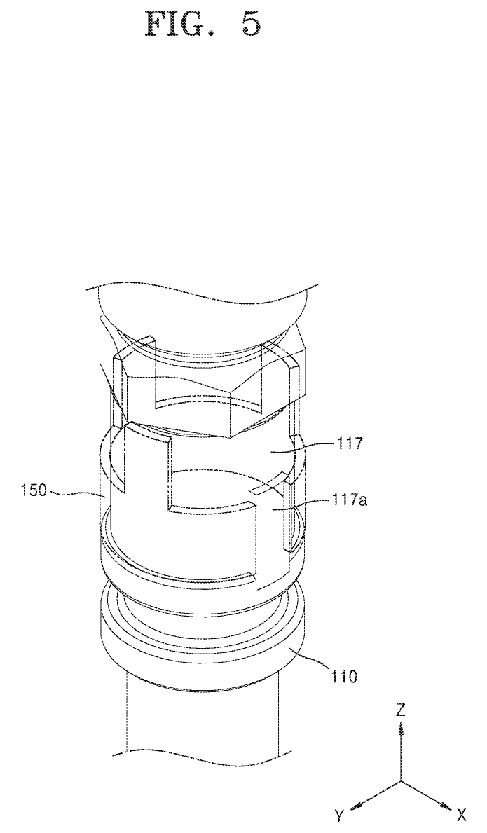

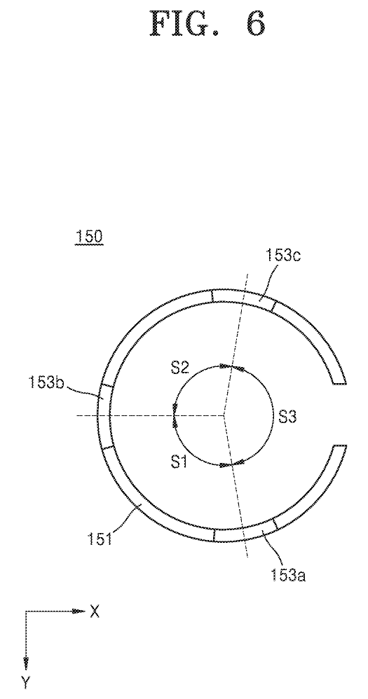

FIG. 4 is a view illustrating a state where the rotation prevention ring 150 is unfolded, according to embodiments. FIG. 5 is a perspective view illustrating a state where the rotation prevention ring 150 is coupled to the tube 110, according to embodiments. FIG. 6 is a plan view illustrating the rotation prevention ring 150 coupled to the tube 110.

The rotation prevention ring 150 may function as a rotation prevention unit for preventing the tube 110 from rotating around the axial direction A of the tube 110. Referring to FIG. 2, the rotation prevention ring 150 may be coupled to the tube 110. One side of the rotation prevention ring 150 may be bent and coupled to the support portion 140, which will be described below in detail. Referring to FIG. 4, the rotation prevention ring 150 may include a ring body 151 and a protrusion 153.

The ring body 151 may contact an outer circumferential surface of the tube 110. The ring body 151 may extend in the circumferential direction P of the tube 110. When the ring body 151 is coupled to the tube 110, both ends of the ring body 151 in a Y-axis direction may contact both ends of the stepped portion 117a described above. A width of the ring body 151 in a Z-axis direction is not particularly limited. A thickness of the ring body 151 is not particularly limited. In an embodiment, referring to FIG. 5, a thickness of the ring body 151 may be the same as a protrusion degree (i.e. a thickness) of the stepped portion 117a.

The protrusion 153 may prevent rotation of the tube 110 by fixing the rotation prevention ring 150 together with the slot 141 in the circumferential direction P of the tube 110. The protrusion 153 may protrude from a first side of the ring body 151 in the axial direction A of the tube 110. The first side may refer to the Z-axis direction.

At least one protrusion may 153 may be formed. In other words, a plurality of protrusions 153 may be formed. Referring to FIGS. 4 and 6, the protrusion 153 may include a first protrusion 153a, a second protrusion 153b, and a third protrusion 153c. Although only three protrusions 153 are illustrated, this is only an example for convenience of explanation, and the number of protrusions 153 is not limited thereto.

The plurality of protrusions 153 may be spaced apart from each other in the circumferential direction P of the tube 110. Intervals S between two adjacent protrusions from among the plurality of protrusions 153 may be different from each other. Referring to FIG. 6, an interval S1 between the first protrusion 153a and the second protrusion 153b, an interval S2 between the second protrusion 153b and the third protrusion 153c, and an interval S3 between the third interval 153C and the first protrusion 153a may be different from each other, whose effect will be described below.

An outer diameter of the rotation prevention ring 150 may correspond to an inner diameter of the support portion 140. Accordingly, when the rotation prevention ring 150 coupled to the tube 110 passes through the support portion 140, there may be no gap between the support portion 140 and the rotation prevention ring 150, and thus, separation of the rotation prevention ring 150 may be prevented when a torque is applied to the tube 110.

Hereinafter, the principle and effect of preventing rotation of the tube 110 due to the slot 141 and the protrusion 153 will be described.

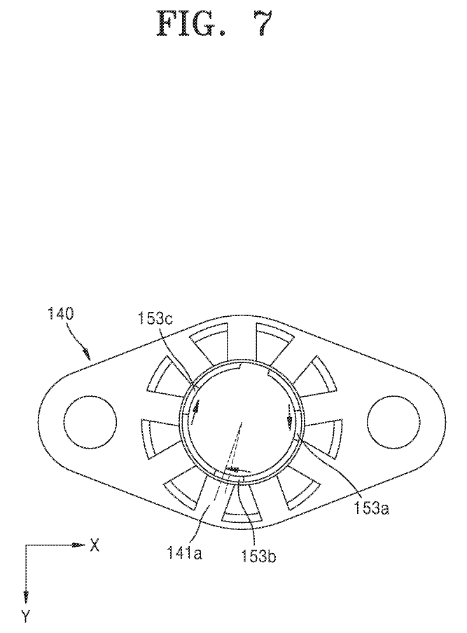

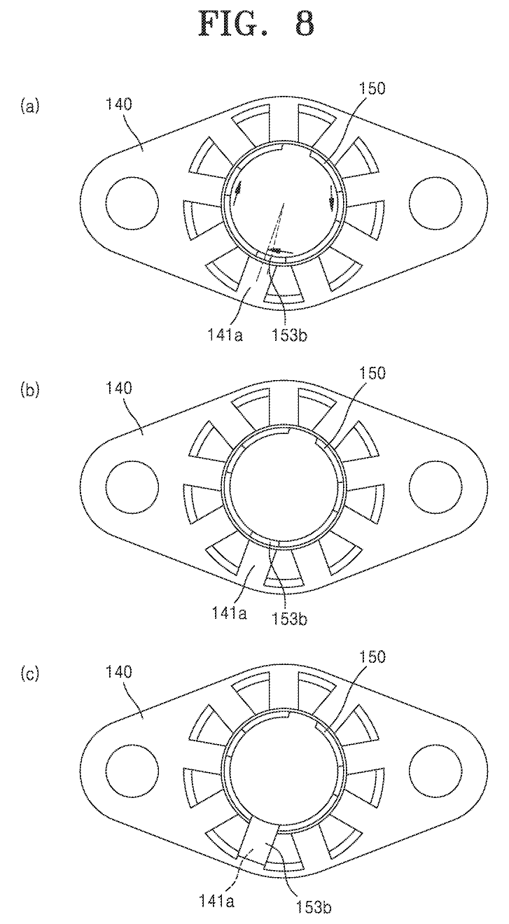

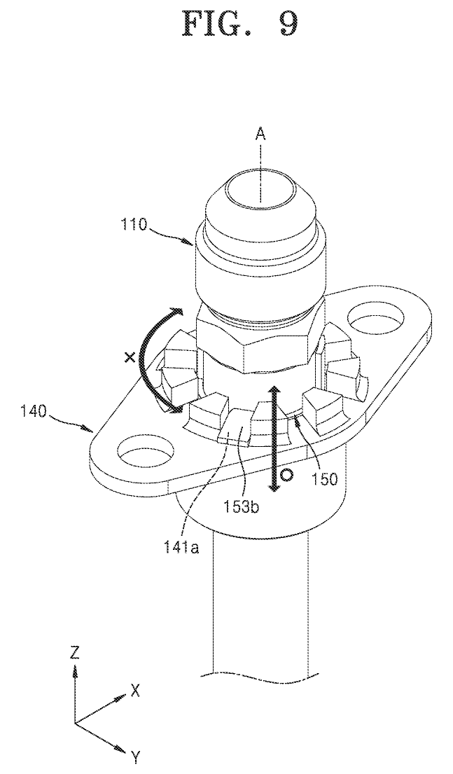

FIG. 7 is a view illustrating a state where the rotation prevention ring 150 is moved to couple one protrusion (e.g., 153b) from among the plurality of protrusions to one slot (e.g., 141a) from among the plurality of slots. FIG. 8 is a view illustrating a process of coupling the second protrusion 153b to a first slot 141a by rotating the tube 110 to which the rotation prevention ring 150 is coupled. FIG. 9 is a view illustrating a state where the support portion 140 and the rotation prevention ring 150 are coupled to each other, according to embodiments.

The protrusion 153 may be bent outward in the radial direction R of the tube 110. The protrusion 153 may be bent outward in the radial direction R of the tube 110 and may be inserted into the slot 141. Accordingly, the rotation prevention ring 150 may be fixed in the circumferential direction P of the tube 110. As described above, the tube 110 and the rotation prevention ring 150 may integrally rotate or stop in the circumferential direction P of the tube 110 due to the stepped portion 117a. In conclusion, the tube 110 may be prevented from rotating by being fixed in the circumferential direction P of the tube 110. Furthermore, as the rotation of the tube 110 is prevented, the tube 110 may be prevented from being loosened from the first case C1.

In order for the protrusion 153 to be inserted into the slot 141, positions of the protrusion 153 and the slot 141 should be matched, and in order to move the protrusion 153, the tube 110 to which the rotation prevention ring 150 is coupled may be rotated. When phases are aligned in the specification, it means that the tube 110 is rotated to match positions of the protrusion 153 and the slot 141 each other so that the protrusion 153 is bent and inserted into the slot 141.

As described above, the tube 110 may be coupled and fixed to the first case C1, and the support portion 140 may be coupled and fixed to the second case C2. When the tube 110 is coupled and fixed to the first case C1 and the support portion 140 is coupled and fixed to the second case C2, phases of the slot 141 and the protrusion 153 may have to be aligned.

As described above, the tube fastening structure 10 may include a plurality of slots 141 and a plurality of protrusions 153. When only one protrusion 153 from among the plurality of protrusions is inserted into one slot 141 from among the plurality of slots, the anti-rotation function and anti-loosening function of the tube 110 may be implemented. Accordingly, as there are the plurality of slots 141 and the plurality of protrusions 153, a range of choices for combinations of the slots 141 and the protrusions 153 whose phases may be aligned may increase.

In order to align phases of the slot 141 and the protrusion 153, the tube 110 may be rotated. However, because the tube 110 is already coupled and fixed to the first case C1, a torque may be applied to the tube 110 within an allowable range of a tightening torque between the first case C1 and the case coupling portion 113 of the tube 110. The allowable range of the tightening torque may be determined according to a ratio of a pitch and a thread length and/or a thread height of the first case C1 and the case coupling portion 113.

As described above, the plurality of slots 141 may be arranged at equal intervals in the circumferential direction P of the tube 110. On the other hand, intervals S between two adjacent protrusions from among the plurality of protrusions 153 may be different from each other. Accordingly, there may be a combination of the slot 141 and the protrusion 153 whose phases may be aligned by applying a torque to the tube 110 within the allowable range of the tightening torque between the first case C1 and the case coupling portion 113.

When the tube 110 passes through the support portion 140 in a state where the rotation prevention ring 150 is coupled to the tube 110, only the support portion 140 and the rotation prevention ring 150 may be shown as in FIG. 7. In the case of FIG. 7, among the first protrusion 153, the second protrusion 153b, and the third protrusion 153c, a protrusion that may be aligned with a phase of the slot 141 by moving the least is the second protrusion 153b. A torque applied to the tube 110 in order to move the second protrusion 153b to be aligned with a phase of the first slot 141a may be within the allowable range of the tightening torque between the first case C1 and the case coupling portion 113.

Referring to (a) of FIG. 8, when the second protrusion 153b is moved by applying a torque to the tube 110 clockwise, phases of the first slot 141a and the second protrusion 153b may be aligned as shown in (b) of FIG. 8. Next, referring to (c) of FIG. 8, the second protrusion 153b may be bent outward in the radial direction R of the tube 110 to be inserted into the first slot 141a.

An effect achieved by inserting the protrusion 153 into the slot 141 is as follows.

Referring to the example of FIG. 9, as the second protrusion 153b is inserted into the first slot 141a, the tube 110 may be fixed in the circumferential direction P of the tube 110, thereby preventing rotation. Furthermore, as the rotation of the tube 110 is prevented, the tube 110 may be prevented from being loosened from the first case C1.

Only rotation of the tube 110 is restricted by the first slot 141a and the second protrusion 153b, and there is no restriction on displacement in the radial direction R of the tube 110 and the axial direction A of the tube 110. Accordingly, even when the tube 110 or the rotation prevention ring 150 is affected by a surrounding high-temperature environment and thermal displacement occurs in the axial direction A of the tube 110 and/or the radial direction R of the tube 110, the tube 110 or the rotation prevention ring 150 may not be affected. Also, even when the case C or the fluid supply target B is subjected to thermal displacement in the axial direction A of the tube 110 and/or the radial direction R of the tube 110, the thermal displacement may be absorbed, thereby maintaining the anti-rotation function and anti-loosening function of the tube 110.

The tube fastening structure 100 has the following effects. As shapes of the support portion 140 including the slot 141 and the rotation prevention ring 150 including the protrusion 153 are simple, manufacturing costs are low. When fluid leakage occurs or maintenance is required during operation, the tube 110 may be separated from the first case C1 and the support portion 140 may be separated from the second case C2 to perform maintenance on the tube 110 in the outside. Accordingly, the inconvenience of having to disassemble the case C itself may be avoided, and the spatial constraints of having to perform maintenance on the tube 110 while the tube 110 is fixed to the case C may be avoided. Accordingly, the efficiency of maintenance may be improved.

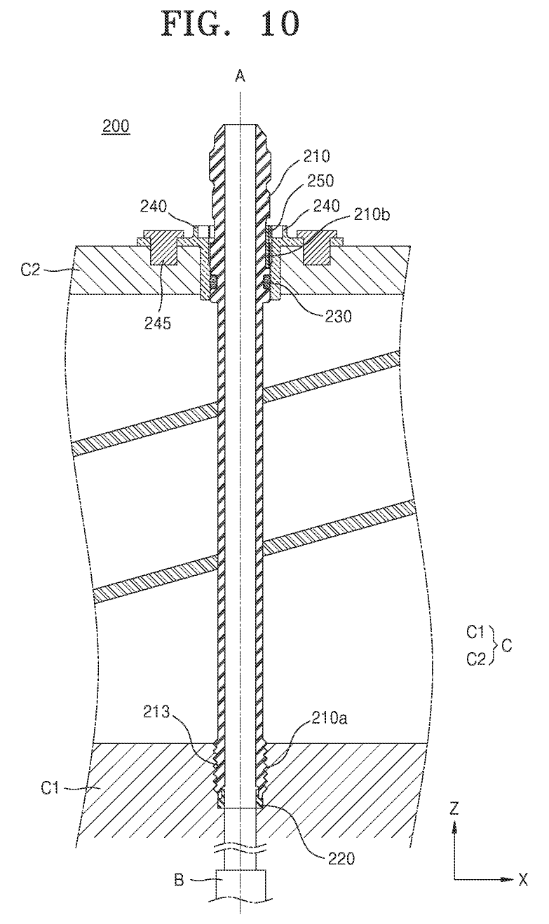

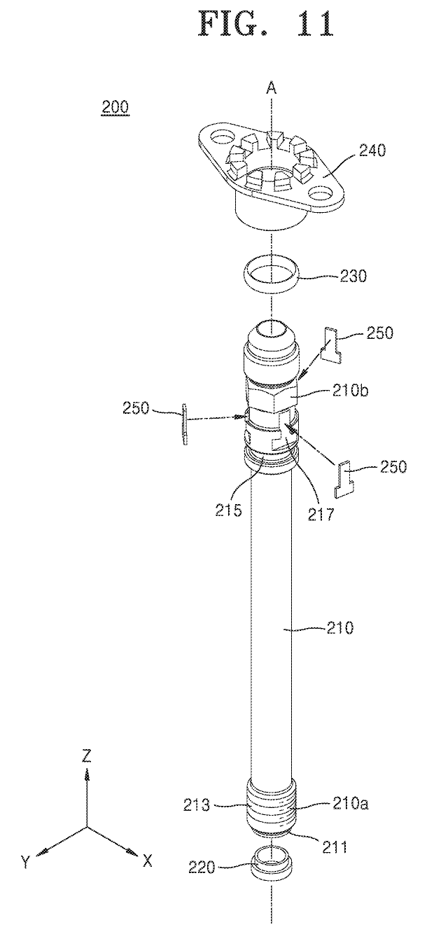

FIG. 10 is a cross-sectional view illustrating a tube fastening structure 200, according to other embodiments. FIG. 11 is an exploded perspective view illustrating the tube fastening structure 200, according to other embodiments.

Referring to FIG. 10, the tube fastening structure 200 may include a tube 210, a bushing 220, a contact member 230, a support portion 240, and a rotation prevention strip 250. Among them, all elements except a strip coupling portion 217 of the tube 210, that is, the bushing 220, the contact member 230, and the support portion 240 are the same as or similar to the tube 110, the bushing 120, the contact member 130, and the support portion 140 of the tube fastening structure 100 described above, and thus, a detailed description thereof will be omitted and a difference will be mainly described.

Referring to FIG. 11, the tube 210 may include a bushing coupling portion 211, a case coupling portion 213, a contact member coupling portion 215, and the strip coupling portion 217. Among them, the bushing coupling portion 211, the case coupling portion 213, and the contact member coupling portion 215 are the same as or similar to the bushing coupling portion 111, the case coupling portion 113, and the contact member coupling portion 115 of the tube fastening structure 100 described above, and thus, a detailed description thereof will be omitted.

Referring to FIG. 11, the rotation prevention strip 250 described below may be coupled to the strip coupling portion 217. The strip coupling portion 217 may be located on an outer surface of a second end 210b of the tube 210. At least one strip coupling portion 217 may be provided. That is, a plurality of strip coupling portions 217 may be provided. Although three strip coupling portions 217 are illustrated in FIG. 11, this is only an example, and the disclosure is not limited thereto. The number of strip coupling portions 217 may correspond to the number of rotation prevention strips 250. A specific shape of the strip coupling portion 217 will be described below.

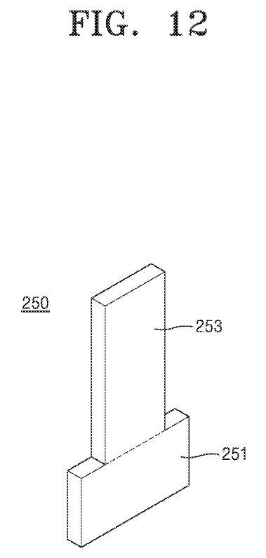

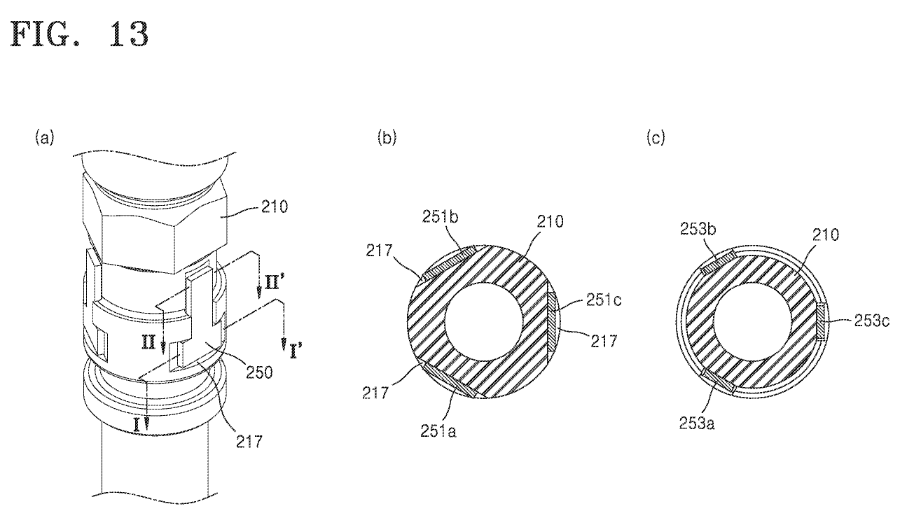

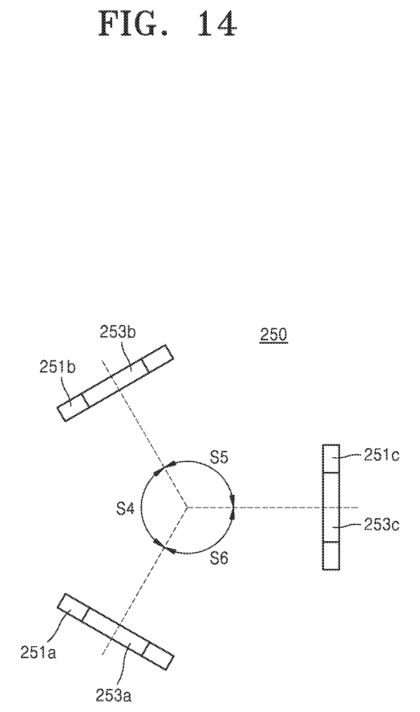

FIG. 12 is a view illustrating the rotation prevention strip 250, according to embodiments. FIG. 13 is a view illustrating a state where the rotation prevention strip 250 is coupled to the tube 210, according to embodiments. FIG. 14 is a plan view illustrating the rotation prevention strip 250 coupled to the tube 210.

The rotation prevention strip 250 may function as a rotation preventing unit for preventing the tube 210 from rotating around the axial direction A of the tube 210. Referring to FIG. 11, the rotation prevention strip 250 may be coupled to the tube 210. One side of the rotation prevention strip 250 may be bent and coupled to the support portion 240, which will be described below in detail. Referring to FIG. 12, the rotation prevention strip 250 may include a strip body 251 and a protrusion 253.

The strip body 251 may contact an outer circumferential surface of the tube 210. The strip body 251 may extend in a direction perpendicular to the axial direction A of the tube 210. A width of the strip body 251 in the Z-axis direction is not particularly limited. A thickness of the strip body 251 may be limited to a degree that the strop body 251 does not protrude out of the outer circumferential surface of the tube 210 when the strip body 251 is coupled to the strip coupling portion 217. Accordingly, the rotation prevention strip 250 coupled to the tube 210 may pass through the support portion 240.

The protrusion 253 may prevent rotation of the tube 210 by fixing the rotation prevention strip 250 together with a slot 241 in the circumferential direction P of the tube 210. The protrusion 253 may protrude from a first side of the strip body 251 in the axial direction A of the tube 210. The first side may refer to the Z-axis direction.

(b) of FIG. 13 is a cross-sectional view taken along line I-I’ of (a) of FIG. 13, illustrating a state where the strip body 251 contacts the strip coupling portion 217. (c) of FIG. 13 is a cross-sectional view taken along line II-II’ of (a) of FIG. 13, illustrating a state where the protrusion 253 contacts the strip coupling portion 217. As shown in FIG. 13, the strip coupling portion 217 may have a groove shape corresponding to a shape of the rotation prevention strip 250.

A portion of the strip coupling portion 217 contacting the strip body 251 may include a bottom surface perpendicular to the axial direction A of the tube 210. A portion of the strip coupling portion 217 contacting the protrusion 253 may include a stepped portion so that the protrusion 253 is fixed in the circumferential direction P of the tube 210. Accordingly, when the rotation prevention strip 250 is coupled to the tube 210, the rotation prevention strip 250 may be fixed to the tube 210 without rotating separately from the tube 210 in the circumferential direction P of the tube 210. That is, the tube 210 and the rotation prevention strip 250 coupled to the tube 210 may integrally rotate or stop in the circumferential direction P of the tube 210 due to the stepped portion. In other words, when a torque is applied to the tube 210, the rotation prevention strip 250 may move together with the tube 210 in the circumferential direction P of the tube 210.

At least one rotation prevention strip 250 may be provided. In other words, a plurality of rotation prevention strips 250 may be provided. Referring to FIGS. 13 and 14, the rotation prevention strip 250 may include a first rotation prevention strip including a first strip body 251a and a fourth protrusion 253a, a second rotation prevention strip including a second strip body 251b and a fifth protrusion 253b, and a third rotation prevention strip including a third strip body 251c and a sixth protrusion 253c. Although three rotation prevention strips 250 are illustrated, this is only an example for convenience of explanation, and the number of rotation prevention strips 250 is not limited thereto.

The plurality of rotation prevention strips 250 may be spaced apart from each other in the circumferential direction P of the tube 210. Intervals S between two adjacent rotation prevention strips from among the plurality of rotation prevention strips 250 may be different from each other. Referring to FIG. 14, an interval S4 between the fourth protrusion 253a and the fifth protrusion 253b, an interval S5 between the fifth protrusion 253b and the sixth protrusion 253c, and an interval S6 between the sixth protrusion 253c and the fourth protrusion 253a may be different from each other, whose effect will be described below.

Hereinafter, the principle and effect of preventing rotation of the tube 210 due to the slot 241 and the protrusion 253 will be described.

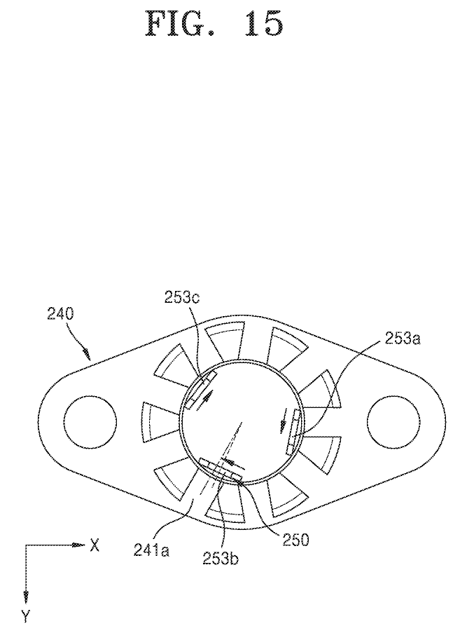

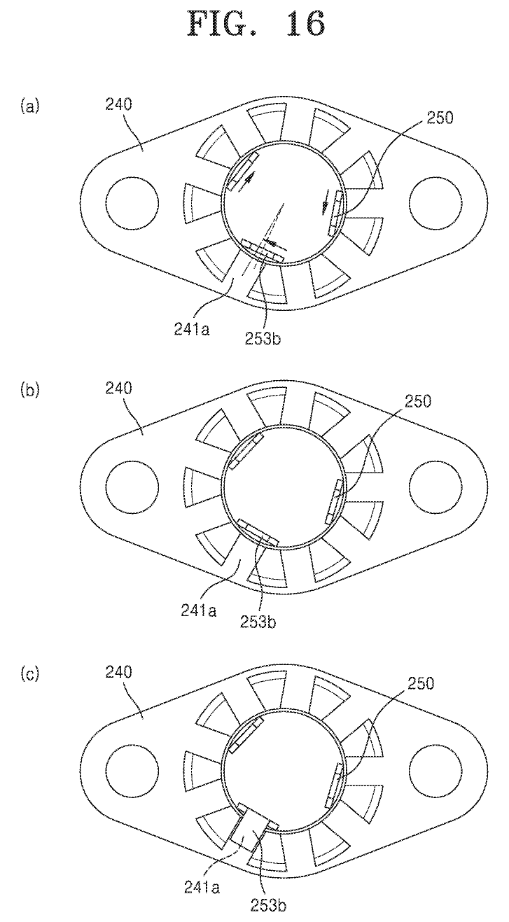

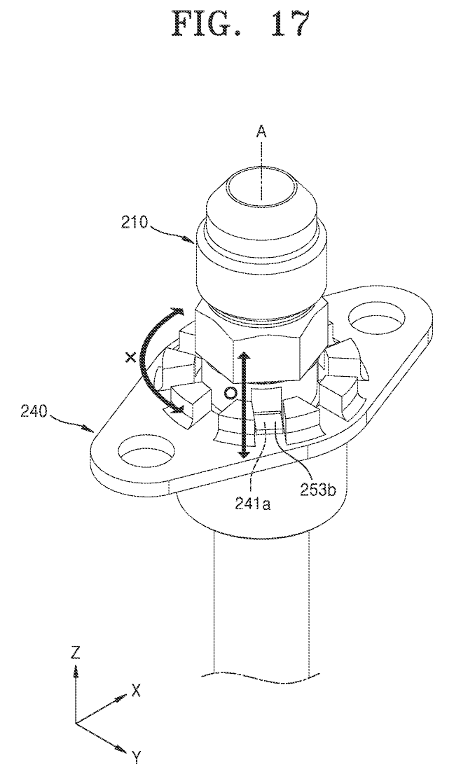

FIG. 15 is a view illustrating a state where the rotation prevention strip 250 is moved to couple one protrusion (e.g., 253b) from among the plurality of protrusions to one slot (e.g., 241a) from among the plurality of slots. FIG. 16 is a view illustrating a process of coupling the fifth protrusion 253b to a second slot 241a by rotating the tube 210 to which the rotation prevention strip 250 is coupled. FIG. 17 is a view illustrating a state where the support portion 240 and the rotation prevention strip 250 are coupled to each other, according to embodiments.

The protrusion 253 may be bent outward in the radial direction R of the tube 210. The protrusion 253 may be bent outward in the radial direction R of the tube 210 and may be inserted into the slot 241. Accordingly, the rotation prevention strip 250 may be fixed in the circumferential direction P of the tube 210. As described above, the tube 210 and the rotation prevention strip 250 may integrally rotate or stop in the circumferential direction P of the tube 210 due to a shape of the stepped portion of the strip coupling portion 217. In conclusion, the tube 210 may be prevented from rotating by being fixed in the circumferential direction P of the tube 210. Furthermore, as the rotation of the tube 210 is prevented, the tube 210 may be prevented from being loosened from the first case C1.

In order for the protrusion 253 to be inserted into the slot 241, positions of the protrusion 253 and the slot 241 should be matched, and in order to move the protrusion 253, the tube 210 to which the rotation prevention strip 250 is coupled may be rotated. When phases are aligned in the specification, it means that the tube 210 is rotated to match positions of the protrusion 253 and the slot 241 so that the protrusion 253 is bent and inserted into the slot 241.

The tube 210 may be coupled and fixed to the first case C1, and the support portion 240 may be coupled and fixed to the second case C2. When the tube 210 is coupled and fixed to the first case C1 and the support portion 240 is coupled and fixed to the second case C2, phases of the slot 241 and the protrusion 253 may have to be aligned.

The tube fastening structure 200 may include a plurality of slots 241 and a plurality of protrusions 253. When only one protrusion 253 from among the plurality of protrusions is inserted into one slot 241 from among the plurality of slots, the anti-rotation function and anti-loosening function of the tube 210 may be implemented. Accordingly, as there are the plurality of slots 241 and the plurality of protrusions 253, a range of choices for combinations of the slots 241 and the protrusions 253 whose phases may be aligned may increase.

In order to align phases of the slot 241 and the protrusion 253, the tube 210 may be rotated. However, because the tube 210 is already coupled and fixed to the first case C1, a torque may be applied to the tube 210 within an allowable range of a tightening torque between the first case C1 and the case coupling portion 213 of the tube 210. The allowable range of the tightening torque may be determined according to a ratio of a pitch and a thread length and/or a thread height of the first case C1 and the case coupling portion 213.

The plurality of slots 241 may be arranged at equal intervals in the circumferential direction P of the tube 210. On the other hand, intervals S between two adjacent protrusions from among the plurality of protrusions 253 may be different from each other. Accordingly, there may be a combination of the slot 241 and the protrusion 253 whose phases may be aligned by applying a torque to the tube 210 within the allowable range of the tightening torque between the first case C1 and the case coupling portion 213.

When the tube 210 passes through the support portion 240 in a state where the rotation prevention strip 250 is coupled to the tube 210, only the support portion 240 and the rotation prevention strip 250 may be shown as in FIG. 15. In the case of FIG. 15, among the fourth protrusion 253a, the fifth protrusion 253b, and the sixth protrusion 253c, a protrusion that may be aligned with a phase of the slot 241 by moving the least is the fifth protrusion 253b. A torque applied to the tube 210 in order to move the fifth protrusion 253b to be aligned with a phase of the second slot 241a may be within the allowable range of the tightening torque between the first case C1 and the case coupling portion 213.

Referring to (a) of FIG. 16, when the fifth protrusion 253b is moved by applying a torque to the tube 210 clockwise, phases of the second slot 241a and the fifth protrusion 253b may be aligned as shown in (b) of FIG. 16. Next, referring to (c) of FIG. 16, the fifth protrusion 253b may be bent outward in the radial direction R of the tube 210 to be inserted into the second slot 241a.

An effect achieved by inserting the protrusion 253 into the slot 241 is as follows.

Referring to the example of FIG. 17, as the fifth protrusion 253b is inserted into the second slot 241a, the tube 210 may be fixed in the circumferential direction P of the tube 210, thereby preventing rotation. Furthermore, as the rotation of the tube 210 is prevented, the tube 210 may be prevented from being loosened from the first case C1.

Only rotation of the tube 210 is restricted by the second slot 241a and the fifth protrusion 253b, and there is no restriction on displacement in the radial direction R of the tube 210 and the axial direction A of the tube 210. Accordingly, even when the tube 210 or the rotation prevention strip 250 is affected by a surrounding high-temperature environment and thermal displacement occurs in the axial direction A of the tube 210 and/or the radial direction R of the tube 210, the tube 210 or the rotation prevention strip 250 may not be affected. Also, even when the case C or the fluid supply target B is subjected to thermal displacement in the axial direction A of the tube 210 and/or the radial direction R of the tube 210, the thermal displacement may be absorbed, thereby maintaining the anti-rotation function and anti-loosening function of the tube 210.

The tube fastening structure 200 has the following effects.

As shapes of the support portion 240 including the slot 241 and the rotation prevention strip 250 including the protrusion 253 are simple, manufacturing costs are low. Furthermore, because the protrusion 253 of only one of the plurality of rotation prevention strips 250 needs to be bent in order to perform the anti-rotation function of the tube 210, the remaining rotation prevention strips 250 whose protrusions 253 are not bent may be reused, thereby saving costs.

When fluid leakage occurs or maintenance is required during operation, the tube 210 may be separated from the first case C1 and the support portion 240 may be separated from the second case C2 to perform maintenance on the tube 210 in the outside. Accordingly, the inconvenience of having to disassemble the case C itself may be avoided, and the spatial constraints of having to perform maintenance on the tube 210 while the tube 210 is fixed to the case C may be avoided. Accordingly, the efficiency of maintenance may be improved.

Although embodiments have been described with reference to the drawings, this is only an example. It will be understood by those of ordinary skill in the art that various changes in form and details may be made therein without departing from the scope of the disclosure. Accordingly, the true technical scope of the disclosure should be defined by the appended claims.

Specific technical content described in the embodiment is an embodiment and does not limit the technical scope of the embodiment. In order to concisely and clearly describe the embodiments, descriptions of general techniques of the related art and configurations may be omitted. Also, lines or members connecting elements illustrated in the drawings are merely illustrative of functional connections and/or physical or circuit connections. In an actual device, the connections between elements may be represented by many alternative or additional functional connections, physical connections, or circuit connections. Moreover, no item or component is essential to the practice of the disclosure unless the item or component is specifically described as “essential” or “critical”.

As used herein, “above” or similar directional terms may be applied to both singular and plural unless otherwise specified. Furthermore, recitation of ranges of values herein are merely intended to serve as a shorthand method of referring individually to each separate value falling within the range, unless otherwise indicated herein, and each separate value is incorporated into the specification as if it were individually recited herein. Also, operations of all methods described herein may be performed in any suitable order unless otherwise indicated herein or otherwise clearly contradicted by context. Embodiments are not limited to the order of the operations. The use of any and all examples, or exemplary language (e.g., “such as”) provided herein, is intended merely to better describe embodiments and does not pose a limitation on the scope of the embodiments unless otherwise claimed. Also, it will be understood by one of ordinary skill in the art that numerous modifications, adaptations, and changes will be made according to design conditions and factors without departing from the spirit and scope of the appended claims.

In a tube fastening structure according to embodiments, because shapes of components are simple, manufacturing costs are low. Also, when fluid leakage occurs or maintenance is required during operation, a tube may be separated and subjected to maintenance in the outside without having to disassemble a case itself. Accordingly, the efficiency of maintenance may be improved.

In the tube fastening structure according to embodiments, the anti-rotation function and anti-loosening function of the tube may be maintained without being affected by thermal displacement in an axial direction of the tube or a radial direction of the tube.

Effects of the disclosure are not limited to the above-mentioned effects, and other effects not mentioned will be clearly understood by one of ordinary skill in the art to which the disclosure pertains from the specification and the attached drawings.

While the present disclosure has been particularly shown and described with reference to exemplary embodiments thereof, it will be understood by those of ordinary skill in the art that the present disclosure is not limited to the same configurations and operations as the specific embodiments described above, and various changes in form and detail may be made therein without departing from the spirit and scope of the present disclosure as defined by the following claims. Therefore, the scope of the present disclosure is defined not by the detailed description of the invention but by the following claims, and all differences within the scope will be construed as being included in the present disclosure.

What is claimed is:

1. A tube fastening structure comprising:
a tube configured to supply a fluid to a fluid supply target;
a support portion through which the tube passes, the support portion being fixed to a case; and
a rotation prevention ring coupled to the tube and having one side configured to be bent and coupled to the support portion.

2. The tube fastening structure of claim 1, wherein the tube comprises a ring coupling portion to which the rotation prevention ring is coupled, and
wherein the ring coupling portion comprises a stepped portion protruding in an axial direction of the tube.

3. The tube fastening structure of claim 1, wherein the support portion comprises at least one slot extending in a radial direction of the tube.

4. The tube fastening structure of claim 3, wherein the at least one slot comprises a plurality of slots, and
wherein each of the plurality of slots is arranged at equal intervals in a circumferential direction of the tube.

5. The tube fastening structure of claim 1, wherein the case comprises:
a first case supporting the fluid supply target; and
a second case at an outer side compared to the first case from the fluid supply target, the first case being closer to the fluid supply target than the second case, and
wherein the support portion further comprises a case fixing portion coupled and fixed to an outer surface of the second case.

6. The tube fastening structure of claim 5, further comprising a bushing coupled to a first end of the tube,
wherein the first case is coupled and fixed to an outer surface of the first end of the tube.

7. The tube fastening structure of claim 1, wherein the rotation prevention ring comprises:
a ring body contacting an outer circumferential surface of the tube and extending in a circumferential direction of the tube; and
at least one protrusion protruding from a first side of the ring body in an axial direction of the tube.

8. The tube fastening structure of claim 7, wherein the at least one protrusion comprises a plurality of protrusions,
wherein the plurality of protrusions are spaced apart from each other in the circumferential direction of the tube, and
wherein an interval between two adjacent protrusions from among the plurality of protrusions is different from another interval between two other adjacent protrusions from among the plurality of protrusions.

9. The tube fastening structure of claim 7, wherein the at least one protrusion is configured to be bent outward in a radial direction of the tube.

10. A tube fastening structure comprising:
a tube configured to supply a fluid to a fluid supply target;
a support portion through which the tube passes, the support portion being fixed to a case; and
at least one rotation prevention strip coupled to the tube and having one side configured to be bent and coupled to the support portion.

11. The tube fastening structure of claim 10, wherein the tube comprises at least one strip coupling portion to which the at least one rotation prevention strip is coupled.

12. The tube fastening structure of claim 10, wherein the support portion comprises at least one slot extending in a radial direction of the tube.

13. The tube fastening structure of claim 12, wherein the at least one slot comprises a plurality of slots, and
wherein the plurality of slots are arranged at equal intervals in a circumferential direction of the tube.

14. The tube fastening structure of claim 10, wherein the case comprises:
a first case supporting the fluid supply target; and
a second case at an outer side compared to the first case from the fluid supply target, the first case being closer to the fluid supply target than the second case, and
wherein the support portion further comprises a case fixing portion coupled and fixed to an outer surface of the second case.

15. The tube fastening structure of claim 14, further comprising a bushing coupled to a first end of the tube,
wherein the first case is coupled and fixed to an outer surface of the first end of the tube.

16. The tube fastening structure of claim 10, wherein the at least one rotation prevention strip comprises a plurality of rotation prevention strips,
wherein the plurality of rotation prevention strips are spaced apart from each other in a circumferential direction of the tube, and
wherein an interval between two adjacent rotation prevention strips from among the plurality of rotation prevention strips is different from another interval between two other adjacent rotation prevention strips from among the plurality of rotation prevention strips.

17. The tube fastening structure of claim 10, wherein the at least one rotation prevention strip comprises:
a strip body contacting an outer circumferential surface of the tube and extending in a direction perpendicular to an axial direction of the tube; and
a protrusion protruding from a first side of the strip body in the axial direction of the tube.

18. The tube fastening structure of claim 17, wherein the protrusion is configured to be bent outward in a radial direction of the tube.

19. A tube fastening structure comprising:
a tube configured to supply a fluid to a fluid supply target;
a support portion through which the tube passes, the support portion being fixed to a case and comprising at least one slot extending in a radial direction of the tube; and
a rotation prevention assembly coupled to the tube and comprising at least one protrusion protruding from one side in an axial direction of the tube.

20. The tube fastening structure of claim 19, wherein the at least one protrusion is configured to be bent outward in the radial direction of the tube and inserted into the at least one slot.
